(19) United States
(12) Patent Application Publication
(10) Pub. No.: US 2024/0335263 A1
(43) Pub. Date: Oct. 10, 2024

(54) BALL HEAD MULTI-UNIT ABUTMENT ASSEMBLY

(71) Applicant: Dan Rosen, Calabasas, CA (US)

(72) Inventor: Dan Rosen, Calabasas, CA (US)

(21) Appl. No.: 18/132,931

(22) Filed: Apr. 10, 2023

(51) Int. Cl. A61C 8/00

(52) U.S. Cl. CPC A61C 8/0069; A61C 8/006

(57) ABSTRACT

A ball head multi-unit abutment assembly is provided for use with a dental implant. The assembly includes a base having an implant bore oriented on-axis with the implant, a coping bore, and a faceted exterior at the bottom of the base configured to seat on the implant. The base also includes a ball head at the top of the base opposite the faceted exterior. The ball head is oriented on-axis with the coping bore. The assembly also has a coping with a stem portion and a seat portion. The seat portion has a ball head receptacle corresponding to the ball head, the stem portion having a coping screw bore, and the base is configured such that when the concave profile is seated on the ball head, the coping screw bore is brought into registration with the coping bore.

### FIELD OF THE INVENTION

The present invention relates to dentistry and more specifically to the field of implant dentistry and multi-unit abutments for dental implants.

### BACKGROUND

A multi-unit abutment is a dental implant component that supports a dental implant framework or restoration in cases where implants are placed at an angle or in multiple areas. It is typically a connecting component that is used in implant dentistry to secure and support a bridge or denture for example. The multi-unit abutment allows multiple dental implants to function together as one unit, providing a stable and reliable foundation for a dental restoration. Multi-unit abutments come in different heights, angles, and shapes to fit a range of implant placement situations, and are typically made from titanium, which is biocompatible and non-corrosive.

Multi-unit abutments, being specifically designed to be used in multiple-implant scenarios, for example where an entire arch is replaced, are also the abutment most frequently used with zygomatic implants, which anchor to the zygomatic bone rather than the maxilla. Zygomatic implants can be an advantageous in the event the quantity or quality of a patient's maxillary bone is insufficient or inadequate. Multi-unit abutments are also applied to the lower jaw or Mandible, and other areas where appropriate, not only a zygomatic implant.

Multi-unit abutments are angled to allow for better prosthetic alignment with the direction of implant placement. The angle allows for an ideal parallel to be established between the prosthetic and the patient's occlusal plane, and improves the distribution of biting forces. The angled design also enables the use of a wide range of prosthetic components and achieve optimal esthetics for a restoration. Additionally, the angled abutment allows for easier access to the screw channel, simplifying the maintenance and repair of the implant when necessary.

Occasionally, in the current art, the connection between a multi-unit abutment base and coping may be prone to flexing or other pressures which can result in degradation and ultimately the failure of a restoration. For these reasons it is an object of the present invention to provide a multi-unit abutment that provides a secure and solid connection between the base and the coping which resists any movement between the two. These and other objects are more fully described in the following summary, description, and drawings.

### SUMMARY

A ball head multi-unit abutment assembly is provided for use with an implant, such as a zygomatic implant, or other similar implant. The assembly includes a base having an implant bore which is oriented on-axis with the implant, and a coping bore for engagement with a coping. The base includes a faceted exterior portion which is configured to seat on the implant. Preferably the faceted exterior portion is also oriented on-axis with the implant. The base includes a semi-spherical ball head opposite the faceted exterior, away from the implant. The ball head is oriented on-axis with the coping bore, such that the coping bore extends directly inward from an apex of the ball head. The angles of the implant relative to the ball head are preferably any angle between 0 and 60 degrees.

The assembly also includes a coping having a stem portion and a seat portion. The seat portion includes a ball head receptacle which correspond in shape to the ball head. The stem portion includes a coping screw bore for insertion into the coping bore on the ball head. The base is configured such that when the concave profile is seated on the ball head, the coping screw bore is brought into registration with the coping bore.

Preferably the implant bore comprises a first upper portion and a first lower portion separated by a first conical portion. The assembly may also include an implant screw configured for insertion into the implant bore once the base is seated on the implant. The implant screw is configured to engage the first conical portion when rotated into the implant to provide greater contact between the head of the implant screw and the base.

The coping bore is oriented at an angle to the implant bore, such that a prosthetic on the coping is at an angle to the implant. In some embodiments the coping bore may be conical in profile, meaning that the threads at the opening to the coping bore have a greater circumference than the threads at the terminal end of the coping bore. In other embodiments, the coping bore extends into the implant bore, thereby forming a passage between the implant bore and the coping bore.

In one embodiment, the faceted exterior may be hexagonal. In other contemplated embodiments the faceted exterior may take a variety of shapes, such as square, octagonal, etc. In still other embodiments, the faceted exterior may use elliptical surfaces in lieu of facets. In all embodiments, the faceted exterior is configured such that the base may not rotate relative to the implant when installed thereon.

The ball head of the base may include a flattened area surrounding the coping bore. Additionally, the base may comprise a base shoulder surrounding the ball head. Preferably when the base shoulder and the flattened area engage the coping, the ball head fully engages the ball head receptacle. In one embodiment, the base comprises a sloped sidewall extending between the faceted exterior and a base shoulder surrounding the ball head.

In other embodiments, the coping may comprise a stem portion and a seat portion. Preferably, the coping screw bore comprises a second upper portion and a second lower portion separated by a second conical portion, like the implant bore. The assembly may include a coping screw configured to engage the second conical portion when rotated into the coping bore of the ball head.

Preferably the seat portion includes comprises a first shoulder and a second shoulder separated by an angled wall. The second shoulder, at a terminal end of the coping, may be larger in circumference than the first shoulder, thereby allowing space under the angled wall for the concave portions of the ball head receptacle. In some embodiments the second shoulder is configured to fully engage a base shoulder of the base when the ball head is seated in the ball head receptacle. Additionally, the ball head receptacle has a concave profile corresponding completely to the shape of the ball head with no space in between. The coping may have flattened areas separated by ridges along the stem portion for holding a prosthesis.

In one preferred embodiment, the coping bore is angled relative to the implant bore greater than fifteen degrees. In another preferred embodiment, the coping bore is angled relative to the implant bore less than sixty degrees. In yet another preferred embodiment, the coping bore is angled relative to the implant bore between fifteen and sixty degrees. In all contemplated embodiments, the angulation may be anywhere between zero (0) and sixty (60) degrees

### BRIEF DESCRIPTION OF THE FIGURES

FIG. 1 illustrates a section elevation view of a ball head multi-unit abutment assembly in accordance with the present invention.

FIG. 2 illustrates an elevation view of the ball head multi-unit abutment assembly with a coping of the assembly angled toward the viewer.

FIG. 3 illustrates a perspective view of the base of the ball head multi-unit abutment assembly.

FIG. 4 illustrates an elevation view of the base with the ball head oriented toward the viewer.

FIG. 5 illustrates a section elevation view of the base with the orientation showing FIG. 4 rotated ninety degrees.

FIG. 6 illustrates an elevation view of the base in the orientation shown in FIG. 5.

FIG. 7 illustrates a perspective view of the coping of the ball head multi-unit abutment assembly.

FIG. 8 illustrates an elevation section view of the coping with the orientation shown in FIG. 7 rotated ninety degrees.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only. They are not intended to limit the embodiments of the present application. Additionally, the drawings are not drawn to scale. Common elements between different figures may retain the same numerical designation.

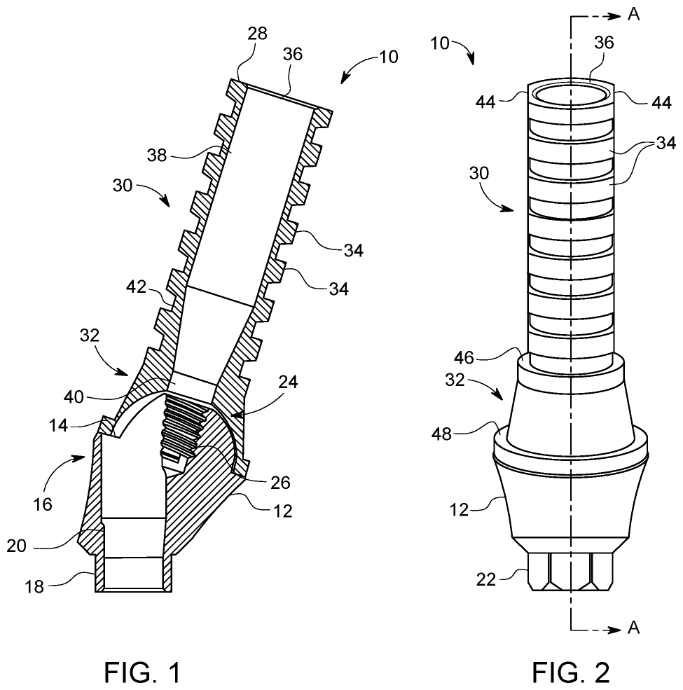

Referring to FIG. 1, a ball head multi-unit abutment assembly 10 is shown in section view. The multi-unit abutment assembly 10 comprises a base 12, which is the lower part of the multi-unit abutment assembly 10. The base 12 will attach to an implant fixture (not shown). The base 12 includes an implant bore 14 which will receive an implant screw (not shown) for attaching the base 12 to the implant. The implant bore 14 includes an implant bore upper portion 16 and an implant bore lower portion 18. The implant bore upper portion 16 is provided to accommodate the implant screw when inserted into the base 12, and the implant bore lower portion 18 allows the base 12 to be inserted into the implant.

An implant bore conical portion 20 is provided for engaging a complimentary conical shoulder (not shown) of the implant screw to achieve a firm and uniform attachment between the base 12 and the implant. The implant bore lower portion 18 includes a faceted exterior 22 (FIG. 2), designed to prevent the base 12 from rotating relative to the implant when installed thereon and tightened against the implant with the implant screw. By providing the implant bore conical section 20 above the faceted exterior 22, where the walls of the base 12 are thinner, in a thicker portion of the base above the faceted exterior 22, the connection between the implant screw and the base 12 is made more resilient to lateral and other forces impacting the ball head multi-unit abutment assembly 10.

Still referring to FIG. 1, The base 12 has a semi-spherical ball head 24 forming the top of the base 12, and projecting upward at an angle relative to the implant bore 14 (and its associated implant screw. The ball head 24 includes a coping or “sleeve” screw bore 26 which receives the threaded end of a coping screw (not shown) that anchors a coping 28 to the base 12. The coping screw bore 26 is preferably oriented along an axis vertical to the ball head 24 (i.e., is “centered” on the ball head) and may extend downward to join the implant bore upper portion 16. The coping screw is prevented from impacting the implant screw, since the top of the implant screw travels downward, closer to the implant bore conical portion 20 when the base 12 is anchored to the implant.

The coping screw bore 26 is preferably threaded for engaging the coping screw, and the ball head 24 presenting a thickened portion of the base 12 helps provide a solid anchorage between the coping 28 and the base 12 once the coping screw is installed. In the illustrated embodiment, the coping screw bore 26 is conically threaded for better anchorage to a coping screw (not shown) which holds the coping 28 to the base 12.

Still referring to FIG. 1, the coping 28 is an elongated structure comprising a stem portion 30 and a seat portion 32. The stem portion is provided with ridges 34 which help anchor a prosthetic (not shown) to the coping 28. The coping 28 includes a coping screw bore 36 for receiving the coping screw. Like the implant bore 14, the coping screw bore 36 includes a coping screw bore upper portion 38, through which the coping screw travels to engage the ball head 24 of the base 12. The coping screw bore 36 also includes a coping screw bore lower portion 40 adapted to receive a neck (not shown) of the coping screw, and a coping screw conical portion 42, which serves the same purpose as the implant bore conical portion 20 (i.e., to receive a shoulder of the coping screw and provide a more resilient anchorage between the coping 28 and the base 12.

FIG. 2 shows the ball head multi-unit abutment assembly 10 in elevation view with the coping 28 oriented toward the viewer, thus the opening to the coping screw bore 36 is shown. In this view opposing flattened walls 44 are provided as part of the stem portion 30 of the coping 28. The flattened walls 44 each provide a faceted surface against which the prosthetic can be anchored such that it does not rotate relative to the coping when installed thereon. Thus, the flattened walls 44 prevent the prosthetic from rotating out of position, while the ridges 34 prevent the prosthetic from moving upward or downward under biting pressure.

Still referring to FIG. 2, the coping 28 may include a first shoulder 46 at the junction of the stem portion and the seat portion 32. In one embodiment the first shoulder 46 may provide a surface for engaging the bottom of the prosthetic. A second shoulder 48 is provided at an end of the seat portion 32 of the coping 28 opposite the stem portion 30. In some embodiments, the second shoulder 48 is adapted to engage the bottom of a prosthetic like the first shoulder 46. The second shoulder 48 also provides a flat surface for engaging the base 12 and surrounding the ball head 24 of the base. By providing the first shoulder 46 and second shoulder 48, an installer of the prosthetic can determine when the prosthetic is sufficiently lowered along the coping 28 to be in the proper vertical position relative to the coping 28, an additional benefit of providing the first shoulder 46 and second shoulder 48 is that they assist the ridges 34 in preventing the prosthetic from moving vertically when cemented in place and put into use.

Still referring to FIG. 2, in addition to forming a seat for the prosthetic, the underside of the second shoulder 48 functions to provide additional anchorage of the seat portion 32 of the coping 28 against the base 12, and seals the ball head 24 within the coping 28 when installed. Opposite the second shoulder 48, the faceted exterior 22 of the base 12 outside the implant bore lower portion 18 (FIG. 1) is shown. In the exemplary illustrated embodiment, a hexagon is shown, but it is anticipated that any number of faceted shapes such as a square, octagon, etc. are contemplated, as long as the base is prevented from rotational movement relative to the implant.

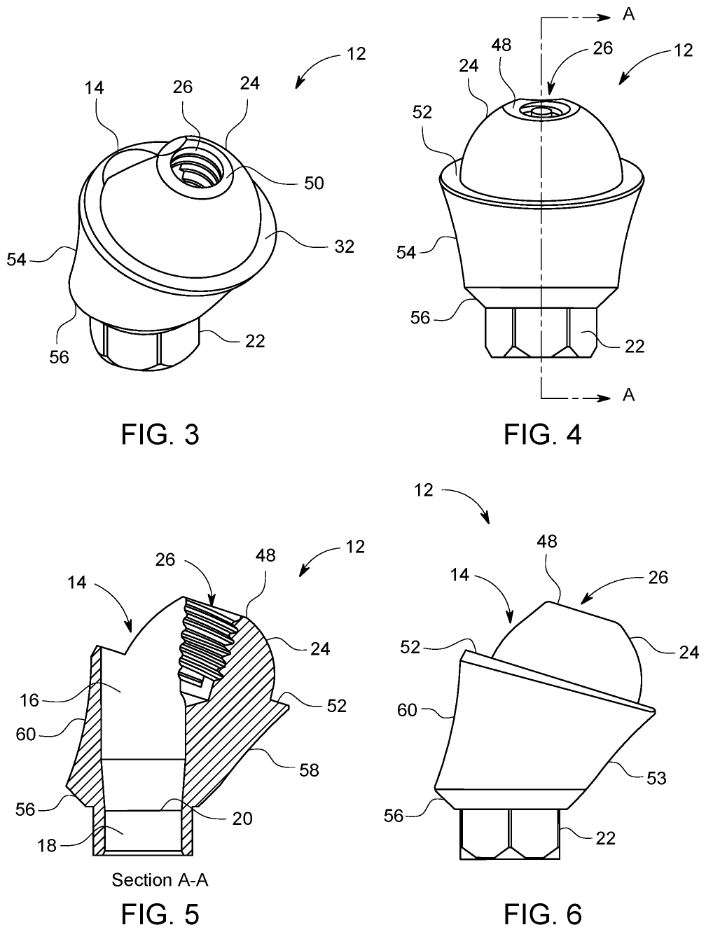

Referring to FIG. 3, the base 12 is shown rotated so that the ball head 24 and coping bore 36 are shown. The ball head 24 and coping bore 36 are positioned at an angle relative to the faceted exterior (and implant screw). This permits a prosthetic to be placed in the proper angle when the implant is at a different angle than the prosthetic, which is common with implants such as zygomatic implants.

As shown in the exemplary illustrated embodiment, the ball head 12 may include a flattened area 50 at the junction of the ball head 12, coping bore 26, coping screw bore 36 (FIG. 1), and coping screw. The flattened area 50 can provide additional registration, ensuring that the coping 28 is properly seated against the base 12. A base shoulder 52 is provided on the base 12. The base shoulder 52 corresponds to the second shoulder 48 of the coping 28 seat portion 32, preferably having the same width. Thus, the base shoulder 52 of the base 12 and the second shoulder 48 of the coping 28 create a seal around the ball head 24 of the base 12.

Still referring to FIG. 3, the base preferably includes a sloped side wall 54 between a transition zone 56 adjacent the faceted exterior 22 and the base shoulder. This helps to provide a transition between the implant site, which is relatively narrow in circumference, and the prosthetic, and provides a space for the patient's gums (not shown) to anneal adjacent the prosthetic. As shown in FIGS. 4, 5, and 6, the transition zone 56 may be angled at a 45 degree angle relative to the faceted exterior 22 at the bottom of the base 12.

Referring to FIG. 4, the base 12 is shown rotated such that the ball head 24 is angled toward the viewer and the implant bore 14 (FIGS. 1, 3) is behind the ball head. In this view the coping bore 26 is shown, surrounded by the flattened area 48 which is impinged upon by the implant bore 14. The base shoulder 52, sloped sidewall 54, and transition zone 56 are also illustrated.

Referring to FIG. 5, the base 12 is shown in section view along section line A in FIG. 4. This illustrates the internal features of the base 12. The coping bore 26 surrounded by the flattened area 48 are at the apex of the ball head 24. The ball head 24 is surrounded by the base shoulder 52. The coping bore 26 extend downward and is partially exposed by the implant bore 14, which extends downward through the base 12, including the implant bore upper portion 16, implant bore lower portion 18, and implant bore conical portion 20.

Still referring to FIG. 5, in this view, the angled nature of the ball head 24 relative to the implant bore 14 (and implant) is highlighted. This results in a leading portion 58 of the sloped sidewall 54, and a trailing portion. The transition zone 56 is adjusted accordingly to provide a transition between the faceted exterior 22 at the bottom of the base 12 and the leading portion 58 and trailing portion 60.

Referring to FIG. 6, the base 12 is shown in the orientation shown in FIG. 5, including the leading portion 58 and trailing portion 60 of the sloped sidewall 54, and the ball head 24 oriented at an angle relative to the implant bore 14. Although a particular angle is shown, it should be understood that the ball head 24 may be angled any number of degrees relative to the implant bore 14. In one contemplated embodiment, any angle between fifteen (15) and sixty (60) degrees is contemplated. Thus, a ball head multi-unit abutment kit (not shown) may have many individual ball head multi-unit abutments having different angles between their ball heads and implant bores.

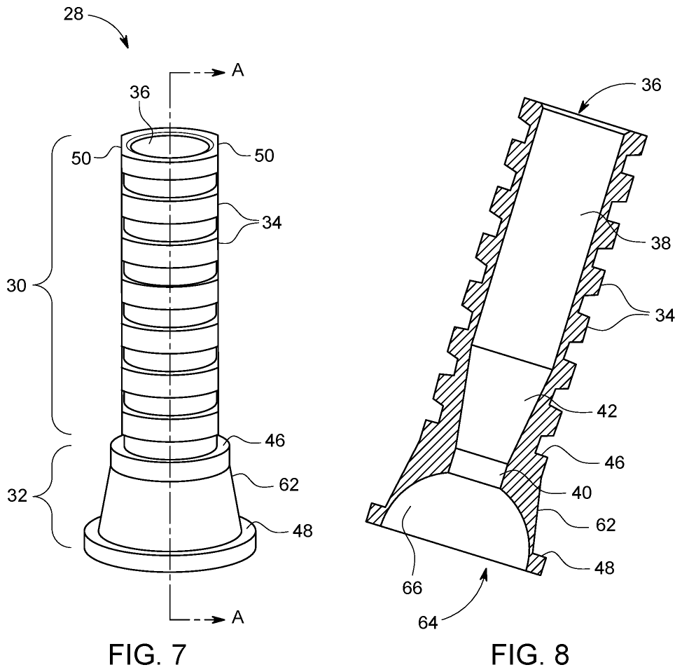

Referring to FIG. 7, the coping 28 is shown in a perspective view oriented with the stem portion 30 toward the user, and oriented with the flattened areas 50 to either side. The ridges 34, surrounding the stem portion 30 are interrupted by the flattened areas 50. Also show in this view is the first shoulder 46 and the second shoulder 48 of the seat portion 32. The seat portion preferably includes an angled wall 62 between the first shoulder 46 and the second shoulder 48. This is to provide space for the ball head 24 when the base 12 is connected to the coping 28, and to provide a smooth transition between the first shoulder 46 and second shoulder 48 where the bottom of a prosthetic can seat in position.

Referring to FIG. 8, a section view of the coping 28 shown in FIG. 7 is shown, rotated ninety degrees. In this view one preferred size of ridges 34 are shown extending away from the stem portion 30 (FIG. 7) of the coping 28. The entrance to the coping screw bore 36 is shown at the top of the coping 28, where the coping screw will be inserted. Also shown are the coping screw upper portion 38, coping screw lower portion 40, and the coping screw bore conical portion 42. Within the seat portion 32, the coping 28 has a ball head receptacle 64 configured with a concave profile 66 corresponding to the convex profile of the ball head 24.

In order to use the ball head multi-unit abutment assembly 10, a user first selects one having the proper angle between the implant bore 14 and the coping bore 26 of the ball head 24. Once an implant is in the desired position and ready for the prosthetic, the user places the base 12 on the implant such that the faceted exterior 22 at the bottom of the base 12 engages the implant, thus preventing rotation of the base 12 relative to the implant. An implant screw is then inserted into the implant bore 14, through the implant bore upper portion 16, and moved down through the implant bore 14 until it extends through the implant bore lower portion 18 and engages the implant. The implant screw can then be tightened such that it engages the implant bore conical portion 20. The base 12 is thus attached to the implant.

Following installation of the base 12, the coping 28 is seated over the base 12. The coping 28 is placed over the ball head 24 such that the ball head receptacle 64 fully engages the ball head 24 along the concave profile 66. When the coping 28 is fully installed over the ball head 24, the second shoulder 48 will fully engage the base shoulder 52 of the base 12. By doing so, the coping screw bore 36 will be brought into registration with the coping bore 26 of the ball head 24.

The coping screw is then inserted into the coping screw bore, travel down the stem portion 30 in the coping screw upper portion, extend through the coping screw lower portion 40 and into the coping bore 26 of the ball head 24. The coping screw is then tightened, such that it engages the coping screw conical portion 42, thereby anchoring the coping 28 to the base 12. Once the coping 28 is anchored to the base 12, a prosthetic can be cemented onto the stem portion 30 of the coping 28, held in place by the ridges 34 and the flattened areas 50, which prevent the prosthetic from moving relative to the implant.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claim.

What is claimed is:

1. A ball head multi-unit abutment assembly for use with an implant, the assembly comprising:
a base having an implant bore oriented on-axis with the implant, a coping bore, and a faceted exterior configured to seat on the implant;
the base further comprising a ball head opposite the faceted exterior, the ball head oriented on-axis with the coping bore;
a coping having a stem portion and a seat portion;
the seat portion having a ball head receptacle corresponding to the ball head;
the stem portion having a coping screw bore; and
wherein the base is configured such that when the concave profile is seated on the ball head, the coping screw bore is brought into registration with the coping bore.

2. The assembly of claim 1 wherein the implant bore comprises a first upper portion and a first lower portion separated by a first conical portion.

3. The assembly of claim 2 further comprising an implant screw configured to engage the first conical portion when rotated into the implant.

4. The assembly of claim 1 wherein the coping bore is oriented at an angle to the implant bore.

5. The assembly of claim 1 wherein the coping bore is conical in profile.

6. The assembly of claim 1 wherein the coping bore extends into the implant bore, thereby forming a passage between the implant bore and the coping bore.

7. The assembly of claim 1 wherein the faceted exterior is hexagonal.

8. The assembly of claim 1 wherein the ball head has a flattened area surrounding the coping bore.

9. The assembly of claim 1 wherein the base comprises a base shoulder surrounding the ball head.

10. The assembly of claim 1 wherein the base comprises a sloped sidewall extending between the faceted exterior and a base shoulder surrounding the ball head.

11. The assembly of claim 1 wherein the coping comprises a stem portion and a seat portion.

12. The assembly of claim 11 wherein the coping screw bore comprises a second upper portion and a second lower portion separated by a second conical portion.

13. The assembly of claim 12 further comprising a coping screw configured to engage the second conical portion when rotated into the coping bore of the ball head.

14. The assembly of claim 1 wherein the seat portion comprises a first shoulder and a second shoulder separated by an angled wall.

15. The assembly of claim 14 wherein the second shoulder is configured to fully engage a base shoulder of the base when the ball head is seated in the ball head receptacle.

16. The assembly of claim 1 wherein the ball head receptacle has a concave profile corresponding to the shape of the ball head.

17. The assembly of claim 1 wherein the coping comprises flattened areas separated by ridges along the stem portion.

18. The assembly of claim 1 wherein the coping bore is angled relative to the implant bore greater than fifteen degrees.

19. The assembly of claim 1 wherein the coping bore is angled relative to the implant bore less than sixty degrees.

20. The assembly of claim 1 wherein the coping bore is angled relative to the implant bore between fifteen and sixty degrees.
